(19) United States
(12) Patent Application Publication
(10) Pub. No.: US 2024/0092681 A1
(43) Pub. Date: Mar. 21, 2024

(54) OPTICAL FIBER PREFORM AND MANUFACTURING METHOD THEREOF

(71) Applicant: Shin-Etsu Chemical Co., Ltd., Tokyo (JP)

(72) Inventor: Yuhei URATA, Ibaraki (JP)

(21) Appl. No.: 18/470,455

(22) Filed: Sep. 20, 2023

(30) Foreign Application Priority Data
Sep. 21, 2022 (JP) 2022-150378

(51) Int. Cl. C03B 37/014

(52) U.S. Cl. CPC C03B 37/0146; C03B 37/0142; C03B 37/01486

(57) ABSTRACT

In the process comprising manufacturing a glass fine particle deposit (soot) by injecting glass fine particles generated with a burner for glass fine particle synthesis to a starting material rotating around its central axis as an axis of rotation; and sintering the glass fine particle deposit to vitrify it into transparent glass by suspending and heating the glass fine particle deposit in a furnace core tube, it is characterized that a product of a time period (min) during which a part of the glass fine particle deposit is heated in a heating zone in the furnace core tube and a linear speed (m/min) of sintering gas flowing in the furnace core tube is 15.5 (m) or more.

The contents of the following patent application(s) are incorporated herein by reference: NO. 2022-150378 filed in JP on Sep. 21, 2022

### BACKGROUND

### 1. Technical Field

The present invention relates to an optical fiber preform, from which an optical fiber is drawn, and a manufacturing method for the optical fiber preform.

### 2. Related Art

An optical fiber preform has, as is the case with an optical fiber, a portion having a higher refractive index in the center than in the periphery (cladding), which is called a core. While a major component of a typical optical fiber for communication is SiO2, the core contains GeO2 as a dopant to increase the refractive index. A manufacturing method of the optical fiber preform includes heating a glass fine particle deposit (soot) manufactured by vapor phase synthesis, such as a vapor phase axial deposition (VAD) method or an outside vapor deposition (OVD) method, and vitrifying it into transparent glass. The optical fiber preform manufactured in this manner is heated and drawn to be thinner, and thereby an optical fiber is obtained.

The VAD method is a method which includes manufacturing the soot by injecting and depositing glass fine particles generated in a burner flame onto a starting material moving vertically upward while rotating. Specifically, the glass fine particles, which are generated by flame hydrolysis reaction and high temperature thermal oxidation reaction caused by supplying silicon chloride such as silicon tetrachloride or the like to an oxyhydrogen flame, are adhered and deposited to the starting material. The soot resulted from the deposition is heated and sintered in a vacuum or inert gas atmosphere, to be dehydrated and vitrified into transparent glass, and thereby the optical fiber preform is obtained.

A heating furnace for the dehydration and the vitrification into transparent glass includes a furnace core tube and a heater surrounding the furnace core tube, and the interior of the furnace core tube may be structured to be shielded from the ambient air. The heater is mounted in the heating furnace body filled with a thermal insulation material and is configured to heat soot via the furnace core tube. In a configuration, the heater is mounted to a middle part in a longitudinal direction of the furnace core tube, and soot suspended in the furnace core tube is dehydrated and vitrified into transparent glass by being passed through the heating zone of the heater. In another configuration, the heater is mounted to an entire area in the longitudinal direction of the furnace core tube, and the soot is dehydrated and vitrified into transparent glass without moving in the furnace core tube.

Currently, reduction of manufacturing cost for the optical fiber preform is desired. One of the factors in the cost increase of the preform manufacturing is sintering gas such as helium gas. The sintering gas is used to dehydrate and vitrify soot into transparent glass. In the process of vitrification into transparent glass, the soot is heated by the heater from the outside and becomes progressively transparent from its surface. As this process proceeds, some sintering gas or air included in the soot may not be able to leave the soot. In this way, the gas trapped in the soot may remain in the glass without being absorbed or dissolved. Such an area does not become transparent and is determined to be defective as an unmelted area. Therefore, occurrence of an unmelted area should be suppressed. The larger the volumetric flow rate of the sintering gas supplied and the longer the process of vitrification into transparent glass, the occurrence of unmelted areas becomes less likely. However, such an approach will entail a cost increase.

An objective of the present invention is to obtain an optical fiber preform and a manufacturing method thereof that enable a glass preform for an optical fiber to be obtained that has fewer unmelted defective areas and of which the transmission loss is not problematic in an optical fiber after being drawn, while requiring as little processing time as possible for vitrification into transparent glass and reducing as much as possible the volumetric flow rate of the sintering gas supplied during the process of vitrification into transparent glass.

### SUMMARY

To achieve the objective above, a study was performed about an optimum balance between the volumetric flow rate of the sintering gas supplied and the processing time required for vitrification into transparent glass. As a result, it was found to be effective, for the reduction of unmelted areas, to establish a lower limit for a product of the He volumetric flow rate per cross-sectional area of the furnace core tube and a time period to heat the soot from its surface facing the heater. The present invention was derived from this finding.

A manufacturing method for an optical fiber preform according to the present invention comprises manufacturing a glass fine particle deposit (soot) by injecting glass fine particles generated with a burner for glass fine particle synthesis to a starting material rotating around its central axis as an axis of rotation; and sintering the glass fine particle deposit to vitrify it into transparent glass by suspending and heating the glass fine particle deposit in a furnace core tube, characterized in that a product of a time period (min) during which a part of the glass fine particle deposit is heated in a heating zone in the furnace core tube and a linear speed (m/min) of sintering gas flowing in the furnace core tube is 15.5 (m) or more. A product of a time period (min) during which a part of the glass fine particle deposit (soot) is heated in a heating zone in the furnace core tube and a linear speed (m/min) of sintering gas flowing in the furnace core tube is preferably 17.6 (m) or more, and more preferably 21.7 (m) or more. Note that the sintering the glass fine particle deposit to vitrify it into transparent glass desirably comprises heating the glass fine particle deposit (soot) by passing it through a heating zone in a furnace core tube. The sintering the glass fine particle deposit (soot) to vitrify it into transparent glass desirably comprises using helium gas as sintering gas.

An optical fiber preform according to the present invention is manufactured by: manufacturing a glass fine particle deposit (soot) by injecting glass fine particles generated with a burner for glass fine particle synthesis to a starting material rotating around its central axis as an axis of rotation; and sintering the glass fine particle deposit to vitrify it into transparent glass by suspending and heating the glass fine particle deposit in a furnace core tube, characterized in that a product of a time period (min) during which a part of the glass fine particle deposit is heated in a heating zone in the furnace core tube and a linear speed (m/min) of sintering gas flowing in the furnace core tube is 15.5 (m) or more.

### BRIEF DESCRIPTION OF THE DRAWINGS

FIG. 1 is a schematic vertical cross-sectional view illustrating an example of a sintering machine.

### DESCRIPTION OF EXEMPLARY EMBODIMENTS

Although embodiments of the present invention are described below in reference to the examples of the present invention and comparative examples based on the drawing, the present invention is not limited to these embodiments, and various aspects are possible within the scope of claims.

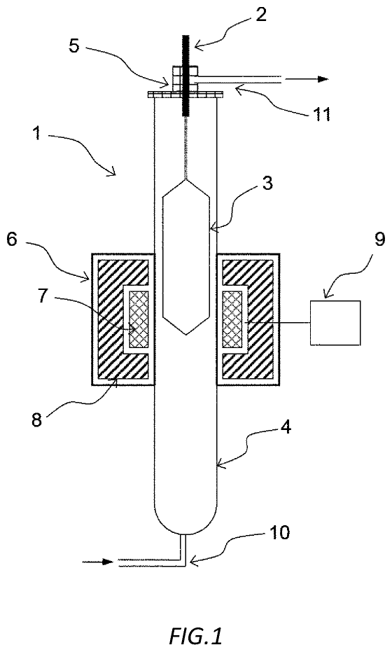

The manufacturing method of the present invention is described in detail. Firstly, by means of the VAD method or the like, soot is manufactured by depositing glass fine particles generated with a burner for glass fine particle deposition. The synthesized soot is heated and sintered in a zone-heating furnace and vitrified into transparent glass to obtain the optical fiber preform. FIG. 1 is a schematic vertical cross-sectional view representing an example of the sintering machine for dehydrating and vitrifying the soot into transparent glass. In FIG. 1, the soot 3 coupled to an axial bar 2 is suspended in the furnace core tube 4 in the sintering machine 1. The axial bar 2 extends through an upper lid 5 and a motor is connected to the axial bar 2 for vertical movement and rotation of the axial bar 2 and the soot 3.

A heating furnace body 6 for heating the soot 3 is arranged around a part of the outer circumference of the furnace core tube 4, and the heating furnace body is provided with a cylindrical heater 7 and a thermal insulation material 8 covering it. A temperature sensor monitors the temperature inside the furnace, and a temperature controller 9 controls the temperature inside the furnace by adjusting the output of the heater 7. A sintering gas introduction conduit 10 is connected to the bottom of the furnace core tube 4 to supply the sintering gas necessary for dehydration and vitrification into transparent glass. The supplied sintering gas flows upwardly and is exhausted through an exhaust conduit 11 at the upper lid 5, so that pressure inside the furnace core tube is adjusted.

### Examples

Soot with a length of 1650 mm and an outer diameter of 160 mm was manufactured by means of the VAD method. The soot was sintered in the sintering machine shown in FIG. 1. Specifically, the soot was suspended in the furnace core tube having an inner diameter of 272 mm, the heater temperature was set to 1200° C. while a mixture gas of chlorine gas and argon gas (chlorine concentration 3 mol %) for dehydration was supplied to the furnace core tube through the gas introduction conduit at the volumetric flow rate of 26 L/min, the soot was heated while being lowered at a lowering rate of 10 mm/min, and the soot was dehydrated. Once the entire soot was heated and dehydrated, the soot was lifted upwardly. Subsequently, the soot was sintered and vitrified into transparent glass, and studied for the presence or absence of unmelted areas.

To study the presence or absence of unmelted areas, examples 1 to 5 and comparative examples 1 and 2 were performed. Table 1 shows the respective conditions of the examples and the comparative examples in terms of the set temperature of the heater, the volumetric flow rate of the helium gas supplied, and the lowering rate. The soots were heated and vitrified into transparent glass based on these conditions applied as set values for respective examples and the comparative examples, and the presence or absence of unmelted areas was studied. Note that, assuming that the lowering rate of the soot is 5.0 mm/min, the heating time period, i.e. the time period during which a part of the soot passes through a heating zone with the height of 300 mm in the cylindrical heater arranged surrounding the furnace core tube, is calculated to be 60 min by dividing the heater height 300 mm by the lowering rate. Assuming that the volumetric flow rate of the helium gas is 33.0 L/min, a linear speed of the helium gas is calculated to be 0.57 m/min by dividing the volumetric flow rate by a cross-sectional area 0.058 m2 of the furnace core tube having an inner diameter of 272 mm. Note that although a helium gas linear speed down to three decimal places was used in calculation of a product of the helium gas linear speed and the heating time required for vitrification into transparent glass, the helium gas linear speed described was rounded to two decimal places for the sake of simplification.

TABLE 1

| | | | | | | PRODUCT OF |
|---|---|---|---|---|---|---|
| | SET | VOLUMETRIC | | | | LINEAR SPEED |
| | TEMPERATURE | FLOW | LINEAR | | HEATING | OF HELIUM GAS |
| | OF THE | RATE OF | SPEED OF | LOWERING | TIME | AND HEATING |
| | HEATER | HELIUM GAS | HELIUM GAS | RATE | PERIOD | TIME PERIOD |
| | [° C.] | [L/min] | [m/min] | [mm/min] | [min] | [m] |
| EXAMPLE 1 | 1555 | 33.0 | 0.57 | 5.0 | 60.0 | 34.1 |
| EXAMPLE 2 | 1555 | 21.0 | 0.36 | 5.0 | 60.0 | 21.7 |
| EXAMPLE 3 | 1555 | 17.0 | 0.29 | 5.0 | 60.0 | 17.6 |
| EXAMPLE 4 | 1570 | 21.0 | 0.36 | 6.0 | 50.0 | 18.1 |
| EXAMPLE 5 | 1605 | 21.0 | 0.36 | 7.0 | 42.9 | 15.5 |
| COMPARATIVE | 1555 | 6.3 | 0.11 | 5.0 | 60.0 | 6.5 |
| EXAMPLE 1 | | | | | | |
| COMPARATIVE | 1605 | 21.0 | 0.36 | 8.0 | 37.5 | 13.6 |
| EXAMPLE 2 | | | | | | |

In example 1, a glass fine particle deposit manufactured was heated to around 1200° C. in a furnace core tube containing chlorine gas, and dehydrated. Then the heater temperature was set to 1555° C. and helium gas was supplied at a volumetric flow rate of 33.0 L/min and the soot was heated while being moved at the lowering rate of 5.0 mm/min and vitrified into transparent glass, to obtain a core glass rod. No occurrence of an unmelted area was observed in a product effective part of this core glass rod. Then, the core glass rod was provided with a cladding externally and drawn to form an optical fiber. The transmission loss of the optical fiber obtained was not problematic. Note that the product of the helium gas linear speed 0.57 m/min and the heating time 60 min required for vitrification into transparent glass was 34.1 m.

In example 2, a glass fine particle deposit manufactured was heated to around 1200° C. in a furnace core tube containing a chlorine gas, and dehydrated. Then the heater temperature was set to 1555° C. and helium gas was supplied at the volumetric flow rate of 21.0 L/min and the soot was heated while being moved at the lowering rate of 5.0 mm/min and vitrified into transparent glass, and then a core glass rod was obtained. No occurrence of an unmelted area was observed in a product effective part of this core glass rod. Then, the core glass rod was provided with a cladding externally and drawn to form an optical fiber. The transmission loss of the optical fiber obtained was not problematic. Note that the product of the helium gas linear speed 0.36 m/min and the heating time 60 min required for vitrification into transparent glass was 21.7 m.

In example 3, a glass fine particle deposit manufactured was heated to around 1200° C. in a furnace core tube containing a chlorine gas, and dehydrated. Then the heater temperature was set to 1555° C. and helium gas was supplied at the volumetric flow rate of 17.0 L/min and the soot was heated while being moved at the lowering rate of 5.0 mm/min and vitrified into transparent glass, and then a core glass rod was obtained. No occurrence of an unmelted area was observed in a product effective part of this core glass rod. Then, the core glass rod was provided with a cladding externally and drawn to form an optical fiber. The transmission loss of the optical fiber obtained was not problematic.

Note that the product of the helium gas linear speed 0.29 m/min and the heating time 60 min required for vitrification into transparent glass was 17.6 m.

In example 4, a glass fine particle deposit manufactured was heated to around 1200° C. in a furnace core tube containing a chlorine gas, and dehydrated. Then the heater temperature was set to 1570° C. and helium gas was supplied at the volumetric flow rate of 21.0 L/min and the soot was heated while being moved at the lowering rate of 6.0 mm/min and vitrified into transparent glass, and then a core glass rod was obtained. No occurrence of an unmelted area was observed in a product effective part of this core glass rod. Then, the core glass rod was provided with a cladding externally and drawn to form an optical fiber. The transmission loss of the optical fiber obtained was not problematic. Note that the product of the helium gas linear speed 0.36 m/min and the heating time 50 min required for vitrification into transparent glass was 18.1 m.

In example 5, a glass fine particle deposit manufactured was heated to around 1200° C. in a furnace core tube containing a chlorine gas, and dehydrated. Then the heater temperature was set to 1605° C. and helium gas was supplied at the volumetric flow rate of 21.0 L/min and the soot was heated while being moved at the lowering rate of 7.0 mm/min and vitrified into transparent glass, and then a core glass rod was obtained. No occurrence of an unmelted area was observed in a product effective part of this core glass rod. Then, the core glass rod was provided with a cladding externally and drawn to form an optical fiber. The transmission loss of the optical fiber obtained was not problematic. Note that the product of the helium gas linear speed 0.36 m/min and the heating time 42.9 min required for vitrification into transparent glass was 15.5 m.

In the comparative example 1, a glass fine particle deposit manufactured was heated to around 1200° C. in a furnace core tube containing a chlorine gas, and dehydrated. Then the heater temperature was set to 1555° C. and helium gas was supplied at the volumetric flow rate of 6.3 L/min and the soot was heated while being moved at the lowering rate of 5.0 mm/min and vitrified into transparent glass, and then a core glass rod was obtained. No occurrence of an unmelted area was observed in a product effective part of this core glass rod. However, an optical fiber, obtained by providing a cladding externally to this core glass rod and being drawn, tended to show high values of a transmission loss, which was a maximum 0.302 dB/km at the wavelength 1383 nm of a transmitted light. Note that the product of the helium gas linear speed 0.11 m/min and the heating time 60.0 min required for vitrification into transparent glass was 6.5 m.

In the comparative example 2, a glass fine particle deposit manufactured was heated to around 1200° C. in a furnace core tube containing a chlorine gas, and dehydrated. Then the heater temperature was set to 1605° C. and helium gas was supplied at the volumetric flow rate of 21.0 L/min and the soot was heated while being moved at the lowering rate of 8.0 mm/min and vitrified into transparent glass, and then a core glass rod was obtained. Occurrence of unmelted areas was observed in a product effective part of this core glass rod. Then, the core glass rod was provided with a cladding externally and drawn to form an optical fiber. The transmission loss of the optical fiber obtained was not problematic. Note that the product of the helium gas linear speed 0.36 m/min and the heating time 37.5 min required for vitrification into transparent glass was 13.6 m. According to the examples, it is possible to obtain the glass preform that has fewer unmelted areas and of which the transmission loss is not problematic in the optical fiber after being drawn, while requiring as little processing time as possible for vitrification into transparent glass and reducing as much as possible the volumetric flow rate of the sintering gas supplied during the process of vitrification into transparent glass.

### EXPLANATION OF REFERENCES

1: sintering machine
2: axial bar
3: soot
4: furnace core tube
5: upper lid
6: heating furnace body
7: heater
8: thermal insulation material
9: temperature controller
10: sintering gas introduction conduit
11: exhaust conduit.

What is claimed is:

1. A manufacturing method for an optical fiber preform, comprising:
manufacturing a glass fine particle deposit (soot) by injecting glass fine particles generated with a burner for glass fine particle synthesis onto a starting material rotating around its central axis as an axis of rotation; and
sintering the glass fine particle deposit to vitrify it into transparent glass by suspending and heating the glass fine particle deposit in a furnace core tube,
wherein a product of a time period (min) during which a part of the glass fine particle deposit is heated in a heating zone in the furnace core tube and a linear speed (m/min) of sintering gas flowing in the furnace core tube is 15.5 (m) or more.

2. The manufacturing method for an optical fiber preform according to claim 1, wherein a product of a time period (min) during which a part of the glass fine particle deposit (soot) is heated in a heating zone in the furnace core tube and a linear speed (m/min) of sintering gas flowing in the furnace core tube is 17.6 (m) or more.

3. The manufacturing method for an optical fiber preform according to claim 1, wherein a product of a time period (min) during which a part of the glass fine particle deposit (soot) is heated in a heating zone in the furnace core tube and a linear speed (m/min) of sintering gas flowing in the furnace core tube is 21.7 (m) or more.

4. The manufacturing method for an optical fiber preform according to claim 1, wherein the sintering the glass fine particle deposit to vitrify it into transparent glass comprises heating the glass fine particle deposit (soot) by passing it through a heating zone in the furnace core tube.

5. The manufacturing method for an optical fiber preform according to claim 1, wherein the sintering the glass fine particle deposit (soot) to vitrify it into transparent glass comprises supplying helium gas as sintering gas.

6. The manufacturing method for an optical fiber preform according to claim 1, wherein a product of a time period (min) during which a part of the glass fine particle deposit (soot) is heated in a heating zone in the furnace core tube and a linear speed (m/min) of sintering gas flowing in the furnace core tube is 34.1 (m) or less.

7. The manufacturing method for an optical fiber preform according to claim 6, wherein a time period (min) during which a part of the glass fine particle deposit (soot) is heated in a heating zone in the furnace core tube is 60 (min) or less.

8. The manufacturing method for an optical fiber preform according to claim 1, wherein a linear speed (m/min) of sintering gas flowing in the furnace core tube is 0.36 (m/min) or more.

9. The manufacturing method for an optical fiber preform according to claim 1, wherein a heating temperature in the sintering is in a range from 1555° C. to 1605° C.

10. An optical fiber preform manufactured by:
manufacturing a glass fine particle deposit (soot) by injecting glass fine particles generated with a burner for glass fine particle synthesis to a starting material rotating around its central axis as an axis of rotation; and
sintering the glass fine particle deposit to vitrify it into transparent glass by suspending and heating the glass fine particle deposit in a furnace core tube,
wherein a product of a time period (min) during which a part of the glass fine particle deposit is heated in a heating zone in the furnace core tube and a linear speed (m/min) of sintering gas flowing in the furnace core tube is 15.5 (m) or more.

11. The optical fiber preform according to claim 10, wherein a product of a time period (min) during which a part of the glass fine particle deposit is heated in a heating zone in the furnace core tube and a linear speed (m/min) of sintering gas flowing in the furnace core tube is 17.6 (m) or more.

12. The optical fiber preform according to claim 10, wherein a product of a time period (min) during which a part of the glass fine particle deposit is heated in a heating zone in the furnace core tube and a linear speed (m/min) of sintering gas flowing in the furnace core tube is 21.7 (m) or more.
